(19) United States
(12) Patent Application Publication
(10) Pub. No.: US 2008/0315640 A1
(43) Pub. Date: Dec. 25, 2008

(54) Vehicle Seat

(75) Inventors: Claudio Bargheer, Holzgerlingen (DE); Thomas Heckmann, Aidlingen (DE); Juergen Schrader, Weil im Schoenbuch (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/885,037

(22) PCT Filed: Feb. 16, 2006
(86) PCT No.: PCT/EP06/01387

§ 371 Date: Aug. 25, 2008

(30) Foreign Application Priority Data
Feb. 26, 2005 (DE) 10 2005 008 840.6

(51) Int. Cl. B60N 2/48

(52) U.S. Cl. 297/220

(57) ABSTRACT

In a vehicle seat with a backrest arranged on a mount and on which at least one head restraint is arranged, an intermediate space formed between a lower delimitation of the head restraint and an upper delimitation the backrest can be covered by a cover device. To reduce a disadvantageous effect on exchangeability, the novel cover device is to be as universally useable as possible and is to readily follow the vertical movement of the head restraint. Accordingly, the present cover device is firstly connected in terms of action to the head restraint and secondly to the backrest in such a manner that, upon a height adjustment of the backrest and/or of the head restraint, an adjustment of the cover device takes place.

### BACKGROUND AND SUMMARY OF THE INVENTION

This invention relates to a vehicle seat with a backrest which is arranged on a mount and on which is arranged at least one head restraint which can be adjusted in one direction and can be arranged at a distance from an upper delimitation of the backrest, with it being possible for an intermediate space to be formed between a lower delimitation of the head restraint and the upper delimitation of the backrest, depending on the position of the head restraint, which intermediate space can be covered by a cover device.

A seat for a convertible with a mount which is arranged on its rear side or in its backrest and in which a wind deflector can be displaced between an effective and an ineffective position is already known (see German document DE 198 32 367 A1). Furthermore, the invention is concerned with a mount, with a wind deflector and with means for attaching it to the rear side or in a backrest of a seat in a convertible, with the wind deflector being displaceable in the mount between an effective and an ineffective position. The known wind deflector is permanently connected fixedly to the backrest and therefore can only be removed in a complicated manner should this be required for space reasons.

The invention is based on the object of designing and arranging the cover device or the wind deflector in such a manner that it readily permits every adjustment of the head restraint.

The object is achieved according to the invention in that the cover device is firstly connected in terms of action to the head restraint and secondly to the backrest in such a manner that, upon a height adjustment of the backrest and/or of the head restraint, an adjustment of the cover device takes place. The very simply and therefore cost-effectively designed cover device makes it possible to very rapidly fit the cover device for use of the vehicle as a convertible, with it always being ensured, upon adjustment of the head restraint, that the intermediate space formed between the head restraint and the backrest is covered.

For this purpose, it is advantageous that the cover device is joined to the backrest and/or to the head restraint via at least one connecting element. The connecting element permits a very rapid attachment and removal of the cover device to and from the head restraint and backrest.

According to a development of the invention, an additional possibility is for the cover device to be connected to the head restraint via at least one first connecting element designed as a hook and to be connected to the backrest via a second connecting element.

Furthermore, it is advantageous that the first connecting element comprises an upwardly open hook and an eye which can be attached in the hook and is joined to the cover device. With the aid of the hook, the cover device can be joined to the head restraint in a simple and rapid manner.

It is also advantageous for the cover device to extend approximately parallel to the rear side of the backrest and to be held, at least in a certain section, such that it can be displaced in guide elements. This ensures an exact adjustment of the cover device on the backrest.

According to a preferred embodiment of the solution according to the invention, it is finally provided that the guide elements comprise one or more guide slots which are provided in the cover device or the backrest and through each of which a guide pin provided on the rear side of the backrest or on the cover device extends. The guide pins held in the guide slots ensure satisfactory, easy adjustment of the cover device.

It is of particular importance for the present invention that the guide pin fastened to the backrest has a cylindrical peg which is held in the guide slot and is adjoined by a peg having a smaller diameter.

In conjunction with the design and arrangement according to the invention, it is advantageous that a securing ring can be fitted on the peg having a smaller diameter. The securing ring can be clipped onto the outer end of the guide pin in a simple manner.

It is furthermore advantageous that the cover device is composed, at least in one region, of an elastic material which permits an extension of the length.

In addition, it is advantageous that the cover device extends at least over the entire width of the head restraint. The elastic or flexible design of the cover device enables the guide element to be omitted.

Further advantages and details of the invention are explained in the patent claims and in the description and are illustrated in the drawings.

### BRIEF DESCRIPTION OF THE DRAWING FIGURES

FIG. 1 shows a schematic illustration of a vehicle seat with a backrest arranged on a mount,

FIG. 2 shows the rear view of the vehicle seat with head restraint and cover device,

FIG. 3 shows a partial view of the fastening device for a cover device,

FIG. 4 shows a guide element with the aid of which the cover device is guided in the vertical direction on the rear side of the vehicle seat, and

FIGS. 4.1 to 4.2 show two further exemplary embodiments of the cover device and guide element.

### DETAILED DESCRIPTION OF THE INVENTION

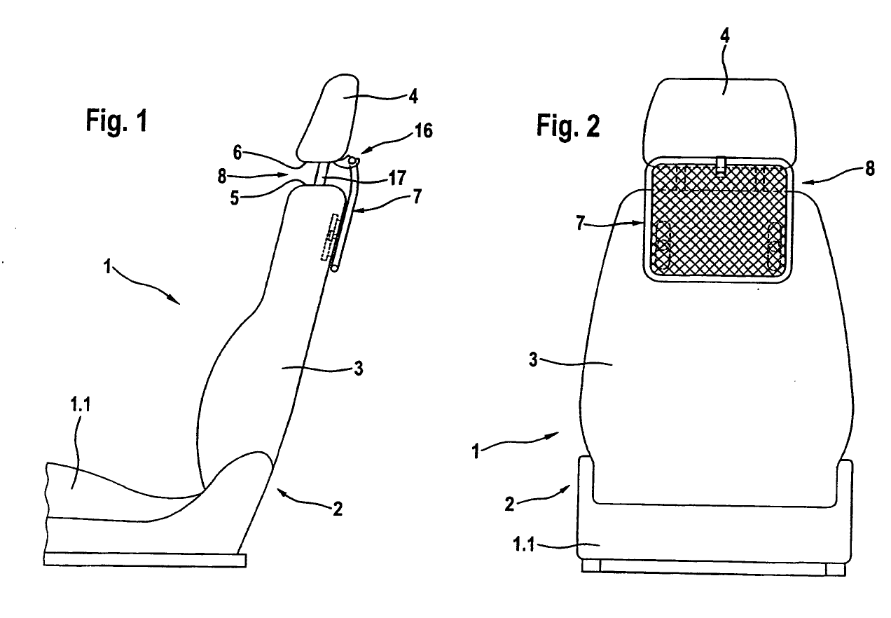

In FIG. 1 of the drawings, 1 refers to a vehicle seat which has a seat part 1.1 with a mount 2 for pivotably holding a backrest 3. A head restraint 4 is arranged at the upper end of the backrest 3, which head restraint can be adjusted at least in one direction and can be arranged at a distance from an upper delimitation 5 of the backrest 3 when the head restraint 4 has been adjusted into a suitable protection position for the driver. The head restraint 4 can also be adjusted downward in the direction of the backrest 3 until a lower delimitation 6 of the head restraint 4 comes to bear against the upper delimitation 5 of the backrest 3. In the other intermediate positions, the lower delimitation 6 of the head restraint 4 and the upper delimitation 5 of the backrest 3 form an intermediate space 8.

When the vehicle is used as a convertible with an open top, the intermediate space 8 can be covered with a cover device 7, which can also be referred to as a wind deflector, in such a manner that swirling of air or a draft in the seat region, in particular in the head restraint region, can be eliminated or reduced to a minimum, and therefore the driver does not perceive any draft.

If the vehicle is traveling as a closed sedan, the cover device 7 can be displaced downward behind the backrest 3 or can be completely removed from the backrest 3. For this purpose, the cover device 7 is equipped with connecting elements and guide parts. The head restraint 4 is mounted at the upper end of the backrest 3 with the aid of two head restraint bars 17 in a manner such that it can be displaced in the vertical direction. Furthermore, the head restraint 4 can also be adjusted on the head restraint bars 17 about a pivot axis which runs horizontally.

A first connecting element comprises an upwardly open hook 16 and an eye 10 which can be attached in the hook and is joined to the cover device 7. The hook 16 is fastened to the lower end of the head restraint 4. The cover device 7 is joined releasably to the lower part of the head restraint 4 with the aid of the hook 16 and the eye 10.

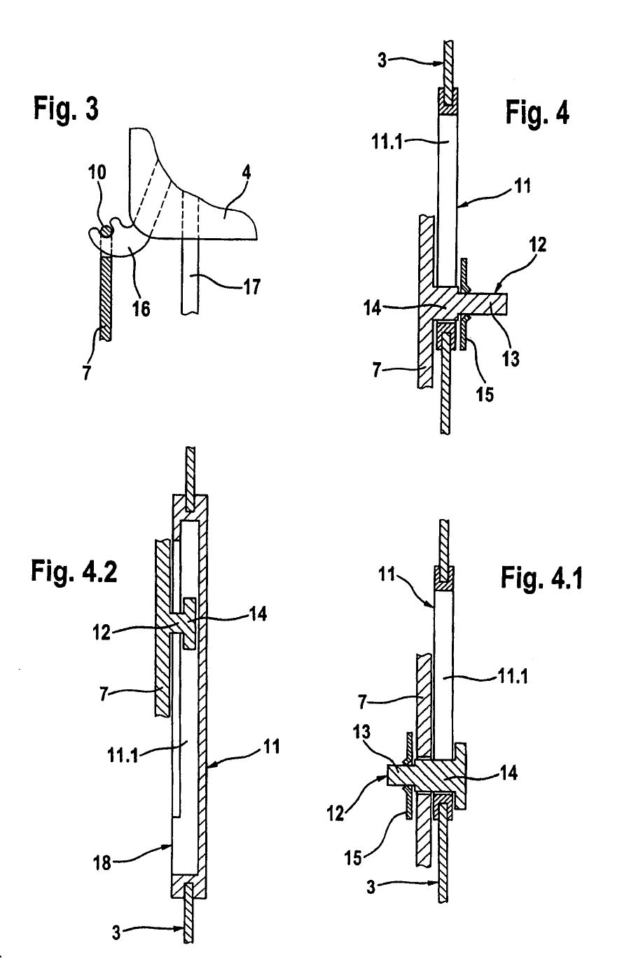

As is apparent from FIGS. 2 to 4, the lower end of the cover device 7 is joined in a height-adjustable manner to the rear side of the backrest 3 with the aid of a guide element 11, and therefore the intermediate space 8 situated between the lower delimitation 6 of the head restraint 4 and the upper delimitation 5 of the backrest 3 can be completely covered if desired during the open traveling mode.

The guide element 11 comprises one or more guide slots 11.1, which are provided in the cover device 7, run parallel to each other, and through each of which a guide pin 12 provided on the rear side of the backrest 3 extends.

The guide pin 12 fastened to the backrest 3 has a cylindrical peg 14 which is held in the guide slot 11.1 of the cover device 7 and is adjoined by a peg 13 having a smaller diameter. A securing ring 15, with the aid of which the cover device 7 can be held on the backrest 3 and can be guided during the upward or downward adjustment of the head restraint 4, can be fitted on the peg 13 having a smaller diameter.

The cover device 7 can be composed of an elastic and/or flexible material or at least of a material which is elastic only in one region, and therefore, during the upward or downward adjustment of the head restraint 4, an extension of the length or a shortening of the cover device 7 and, no matter which position the head restraint 4 assumes, the intermediate space 8 between head restraint 4 and backrest 3 is always completely covered. If the cover device 7 is composed of a material of this type, the guide element 11 can be omitted.

According to a further exemplary embodiment illustrated in FIGS. 4.1 and 4.2, the guide element 11 with the guide slot 11.1 can be embedded in the backrest 3 such that the cover device 7 covers the two parallel guide slots 11.1, in the view according to FIG. 2. The cover device 7 is then guided with the aid of the pegs 13, 14 in the guide slots 11.1 held in the backrest 3.

According to the exemplary embodiment of FIG. 4.2, the guide slot 11.1 is of a length which is somewhat larger than the adjustment distance.

Furthermore, it is possible for the cover device 7 to be composed of an air-impermeable or a semi-permeable fabric and/or of a transparent fabric.

According to a further embodiment, the guide slot 11.1 can be of a length which is substantially larger than the adjustment distance of the head restraint 4 such that the cover device 7 can be pushed downward until the peg 14 can be taken out of a recess 18 provided in the guide slot 11.1 and, after release of the eye 10 from the hook 16, the cover device 7 can be removed from the backrest 3.

1-10. (canceled)

11. A vehicle seat with a backrest which is arranged on a mount and on which is arranged at least one head restraint that can be adjusted in one direction and that can be arranged at a distance from an upper delimitation of the backrest so that an intermediate space can be formed between a lower delimitation of the head restraint and the upper delimitation of the backrest, depending on the position of the head restraint, comprising:
a cover device by which the intermediate space can be covered in order to reduce air turbulence, the cover device being connected and interacting with the head restraint and with the backrest so that, upon a height adjustment of at least one of the backrest and of the head restraint, an adjustment of the cover device takes place,
a first connecting element designed as a hook, and
a second connecting element designed as a guide element,
wherein the cover device is joined height-adjustably to a rear side of the backrest and is completely removable from the backrest by being joined releasably to a lower part of the head restraint via said first connecting element and by being connected to the backrest via said second connecting element.

12. The vehicle seat as claimed in claim 11, wherein the cover device extends approximately parallel to the rear side of the backrest and is held, at least in a certain section, such that it can be displaced in the guide element.

13. The vehicle seat as claimed in claim 11, wherein the first connecting element comprises an upwardly open hook, and wherein an eye, which can be attached in the hook, is joined to the cover device.

14. The vehicle seat as claimed in claim 11, wherein each guide element comprises at least one guide slot provided in the cover device or the backrest through which a guide pin provided on the rear side of the backrest or on the cover device extends.

15. The vehicle seat as claimed in claim 14, wherein the guide pin has a cylindrical peg which is held in the guide slot and is adjoined by a peg having a smaller diameter.

16. The vehicle seat as claimed in claim 15, further comprising a securing ring that can be fitted on the peg having a smaller diameter.

17. The vehicle seat as claimed in claim 11, wherein the cover device is composed, at least in one region, of an elastic material which permits an extension of length.

18. The vehicle seat as claimed in claim 11, wherein the cover device extends over at least the entire width of the head restraint.

19. The vehicle seat as claimed in claim 12, wherein the first connecting element comprises an upwardly open hook, and wherein an eye, which can be attached in the hook, is joined to the cover device.

20. The vehicle seat as claimed in claim 12, wherein each guide element comprises at least one guide slot provided in the cover device or the backrest through which a guide pin provided on the rear side of the backrest or on the cover device extends.

21. The vehicle seat as claimed in claim 13, wherein each guide element comprises at least one guide slot provided in the cover device or the backrest through which a guide pin provided on the rear side of the backrest or on the cover device extends.

22. The vehicle seat as claimed in claim 20, wherein the guide pin has a cylindrical peg which is held in the guide slot and is adjoined by a peg having a smaller diameter.

23. The vehicle seat as claimed in claim 21, wherein the guide pin has a cylindrical peg which is held in the guide slot and is adjoined by a peg having a smaller diameter.

24. The vehicle seat as claimed in claim 22, further comprising a securing ring that can be fitted on the peg having a smaller diameter.

25. The vehicle seat as claimed in claim 23, further comprising a securing ring that can be fitted on the peg having a smaller diameter.

26. The vehicle seat as claimed in claim 12, wherein the cover device is composed, at least in one region, of an elastic material which permits an extension of length.

27. The vehicle seat as claimed in claim 12, wherein the cover device extends over at least the entire width of the head restraint.

28. The vehicle seat as claimed in claim 13, wherein the cover device is composed, at least in one region, of an elastic material which permits an extension of length.

29. The vehicle seat as claimed in claim 13, wherein the cover device extends over at least the entire width of the head restraint.

30. The vehicle seat as claimed in claim 14, wherein the cover device is composed, at least in one region, of an elastic material which permits an extension of length.
